(19) United States
(12) Patent Application Publication
(10) Pub. No.: US 2015/0062713 A1
(43) Pub. Date: Mar. 5, 2015

(54) ANTI-REFLECTION ARTICLE AND METHODS THEREOF

(71) Applicant: CORNING INCORPORATED, Corning, NY (US)

(72) Inventors: Shandon Dee Hart, Corning, NY (US); Kenneth Edward Hrdina, Horseheads, NY (US); Dmitri Vladislavovich Kuksenkov, Elmira, NY (US); Daniel Aloysius Nolan, Corning, NY (US); Ellen Marie Kosik Williams, Painted Post, NY (US)

(21) Appl. No.: 14/471,342

(22) Filed: Aug. 28, 2014

Related U.S. Application Data
(60) Provisional application No. 61/872,037, filed on Aug. 30, 2013.

(51) Int. Cl. G02B 1/11; B05D 3/02; B05D 1/18; B05D 5/02

(52) U.S. Cl. CPC G02B 1/11; B05D 5/02; B05D 3/0254; B05D 1/185
USPC 359/601; 427/162

(57) ABSTRACT

An antireflection article including:
a transparent substrate having a refractive index of from 1.48 to 1.53;
a binder layer associated with the substrate, the binder having a refractive index of from 1.55 to 1.75; and
a nanoparticulate monolayer or near monolayer associated with the binder layer, the nanoparticulate layer having an effective refractive index less than the refractive index of binder. Methods of making and using the article are also disclosed.

This application claims the benefit of priority to U.S. Application No. 61/872,037 filed on Aug. 30, 2013 the content of which is incorporated herein by reference in its entirety.

### CROSS-REFERENCE TO RELATED APPLICATIONS

This present disclosure is related to commonly owned and assigned U.S. Ser. No. 13/440,183, filed Apr. 5, 2012 and published as US2012-0281292; U.S. Ser. No. 61/557,490 now U.S. Ser. No. 13/668,537, filed Nov. 5, 2012; U.S. Ser. No. 61/731,924, filed Nov. 30, 2012; U.S. Ser. No. 13/090,561, filed Apr. 20, 2011; U.S. Ser. No. 13/662,789, filed Oct. 29, 2012; U.S. Ser. No. 13/900,659, filed May 23, 2013; and U.S. Ser. No. 61/872,043 filed Aug. 30, 2013, the entire disclosures of which are incorporated herein by reference, but do not claim priority thereto.

### BACKGROUND

The disclosure relates generally to an anti-reflection (AR) surface, articles thereof, and methods of making and using.

### SUMMARY

In embodiments, the disclosure provides an anti-reflection (AR) coating having at least one layer comprising a monolayer or near-monolayer of nanoparticles.

In embodiments, the disclosure provides an article incorporating the AR coating.

In embodiments, the disclosure provides a method of making the article that includes depositing a binder on the substrate; and depositing the nanoparticulate monolayer or near monolayer on the binder.

In embodiments, the disclosure provides a method of using the article, for example, in a display device, which includes incorporating the disclosed article in a display device.

### BRIEF DESCRIPTION OF THE DRAWING(S)

In embodiments of the disclosure:

FIG. 1 shows an AR article having a multilayer AR surface having a nanoparticle monolayer in a close pack arrangement.

FIGS. 2A and 2B show views (2A side view; 2B top view) of an exemplary AR article having a multilayer AR coating including a nanoparticle monolayer having the nanoparticles in a non-close packed hexagonal arrangement.

FIG. 3 shows a map of coating performance for various pitch/Diameter ratios or values and the high refractive index layer thicknesses normalized to the particle diameter for a high refractive index value of 1.6.

FIGS. 4A and 4B show examples of a reflectivity spectrum taken from the preferred design space of FIG. 3.

FIG. 5 shows a graph providing a comparison between 100 nm particles (no second layer; 500) directly deposited on a substrate, the particles having a refractive index (nₚ) of, for example, 1.51, and a preferred design structure example (having 100 nm particles and having a second intermediate binder layer; 510) from FIG. 4.

FIGS. 6A and 6B shows a graph providing a comparison of spectral widths for the two examples shown in FIG. 5 versus angle of incidence (AOI).

FIGS. 7A through 7E provide exemplary spectra for some values of the high refractive index (n_{g}) layer having a refractive index from 1.55 (FIG. 7A) to 1.75 (FIG. 7E).

FIG. 8 provides a schematic of another article (800) having a glass substrate (810), and a nanoparticle monolayer (830), which nanoparticle monolayer is partially sunken or immersed into a high refractive index layer (820).

FIGS. 9A and 9B show exemplary spectra for design structures in which the nanospheres of the nanoparticulate monolayer are partially immersed into the high refractive index layer.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

### DEFINITIONS

“Antireflection” and like terms refer to a reduction in total reflection (specular and diffuse), which may be induced by a coating or surface treatment.

“Binder,” “binder layer,” and like terms refer to a material that may be used to join or strengthen the bonding between surfaces, such as between particles or between particles and a glass surface.

“Nanoparticulate monolayer” and like terms refer to a single layer of particles, typically in contact with a surface or substrate, where the particles have an average size or average diameter that is generally about 500 nm or less, and the majority of the particles have a size variation that is less than about plus or minus (+/−) 100%. The spacing between the particles is preferably substantially uniform.

“Near-monolayer” and like terms refer to a nanoparticulate monolayer, as defined above, that may have some defective areas such as incomplete surface coverage, or a double-layer stacking of particles, or irregular spacing between the particles. Typically these defective areas will not comprise more than 50% of the total area of the monolayer.

“Associated with” and like terms refer to the relation of a binder layer with respect to the substrate, the relation of a nanoparticles with respect to the substrate, or both, which can include, for example, physical contact, physical interaction such as mechanical interlocking, chemical bonding interaction, and like interactions, or combinations thereof.

“Effective refractive index” and like terms refer to the measured average refractive index of a nanostructured material or coating that can be measured using known optical methods such as ellipsometry or prism coupling, where the measured effective refractive index is some superposition of the refractive indices of the individual materials (such as glass and air) that form the individual nano-domains of the nanostructure. Because the nanostructured material has features that are smaller than visible light wavelengths, the measured refractive index is considered an effective refractive index.

“Reflectivity” and like terms refer to, for example, the article having an average reflectivity of less than 0.1 to 0.2% for a single surface or side of the article over a spectral width of at least 100 nm covering at least a portion of the visible wavelength spectrum from 400 to 700 nm.

A “second binder situated between the nanoparticulate monolayer and the binder” and like terms or phrases refer to, for example, a material that is used to create bonding, such as adhesive, chemical, or like bonding interaction, between nanoparticles, between the nanoparticles and a binder layer, between nanoparticles and a coating layer, between particles and the substrate, or combinations thereof.

“Include,” “includes,” and like terms mean encompassing but not limited to, that is, inclusive and not exclusive.

“About” modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example: through typical measuring and handling procedures used for preparing materials, compositions, composites, concentrates, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

“Consisting essentially of” in embodiments can refer to, for example:
an article having an anti-reflective surface as defined herein;
a method of making or using the anti-reflective article as defined herein; or
a display system that incorporates the article, as defined herein.

The article, the display system, the method of making and using, compositions, formulations, or any apparatus of the disclosure, can include the components or steps listed in the claim, plus other components or steps that do not materially affect the basic and novel properties of the compositions, articles, apparatus, or methods of making and use of the disclosure, such as particular reactants, particular additives or ingredients, a particular agent, a particular surface modifier or condition, or like structure, material, or process variable selected. Items that may materially affect the basic properties of the components or steps of the disclosure or that may impart undesirable characteristics to the present disclosure include, for example, a surface having objectionable high reflectivity properties that are beyond the values, including intermediate values and ranges, defined and specified herein.

The indefinite article “a” or “an” and its corresponding definite article “the” as used herein means at least one, or one or more, unless specified otherwise.

Abbreviations, which are well known to one of ordinary skill in the art, may be used (e.g., “h” or “hr” for hour or hours, “mL” for milliliters, and “rt” for room temperature, “nm” for nanometers, and like abbreviations).

Specific and preferred values disclosed for components, ingredients, additives, and like aspects, and ranges thereof, are for illustration only; they do not exclude other defined values or other values within defined ranges. The compositions, apparatus, and methods of the disclosure can include any value or any combination of the values, specific values, more specific values, and preferred values described herein.

Anti-reflection (AR) coatings have been available for decades. More recent work has focused on fabricating an anti-reflection coating that consists of a monolayer of nanoparticles on a substrate. These nanoparticle monolayers can have unique combinations of characteristics, such as: low reflection; higher durability than nanoporous coatings of equivalent effective refractive index; ease of ion-exchange strengthening of glass substrates that are already coated with the nanoparticle monolayer; lower effective fingerprint visibility compared to multilayer high-low refractive index AR coatings; broad reflection bandwidth, and low angular sensitivity of reflection. These more recent AR coatings and examples of related methods of making are described in the abovementioned related commonly owned and assigned applications.

For a given size and spacing of nanoparticles in the monolayer, it would be generally beneficial to have a method to reduce the minimum reflection, widen the wavelength band of low reflection for the AR coating, or both.

In embodiments, the disclosure provides an antireflection article comprising:
a transparent substrate having a refractive index (nₛ) of from 1.48 to 1.53;
a binder layer (i.e., a coating composition) associated with the substrate, the binder having a relatively high refractive index (n_{g}) of from about 1.55 to about 1.75, which binder layer refractive index (n_{g}) is greater than the refractive index of the transparent substrate (nₛ) (that is, n_{g}>nₛ); and
a nanoparticulate monolayer or near-monolayer associated with the binder layer, the nanoparticulate layer having an effective refractive index (n_{p eff})_{of} less than the refractive index of the binder layer (that is, n_{g}>n_{p eff}), such as an n_{p eff} of less than 1.55.

In embodiments, the effective refractive index of the nanoparticulate monolayer (n_{p eff}) can be, for example, from 1.1 to 1.5, 1.15 to 1.3, and like values, including intermediate values and ranges.

In embodiments, the antireflection reflectivity of the article can have, for example, an average reflectivity of less than 0.2% over a spectral width of at least 100 nm covering at least a portion of the visible wavelength spectrum from 400 to 700 nm.

In embodiments, the nanoparticulate monolayer can include, for example, nanoparticulates in a non-close packed hexagonal geometry having a pitch (p) (i.e., the separation distance between the centers of adjacent nanoparticulates) to nanoparticulate diameter (D) ratio (p/D) of from 1.05 to 1.35, and preferably from 1.15 to 1.25, including intermediate values and ranges.

In embodiments, the binder can have, for example, a thickness from 1×D to 2×D, and preferably from 1.3×D to 1.8×D, including intermediate values and ranges, where D is the nanoparticulate average diameter (D).

In embodiments, the transparent substrate can be, for example, a glass, a polymer, a glass-ceramic, a crystalline oxide, a semiconductor, and like materials, or combinations thereof.

In embodiments, the antireflection article can further comprise, for example, a second binder situated between the nanoparticulate monolayer and the binder.

In embodiments, the nanoparticulate monolayer can have, for example, a nanoparticulate surface coverage of from 85 to 100%, from 90 to 93%, and like surface coverage, including intermediate values and ranges, and the nanoparticulate near-monolayer can comprise, for example, substantially a monolayer of the nanoparticulates having a nanoparticulate surface coverage of from 50 to 90%, from 65 to 90%, and like surface coverage, including intermediate values and ranges. This surface area coverage is measured using standard microscopy, including electron microscopy, and by projecting the visible profile of the nanoparticles onto the substrate surface (e.g., by calculating the percentage of the microscopic surface image where particles are visible, which is considered a covered area versus the percentage where the substrate is visible, which is considered an uncovered area).

In embodiments, the nanoparticulate layer can comprise, for example, nanoparticulates of at least one of: silica, alumina, zirconia, polystyrene, latex, and like materials, or combinations thereof.

In embodiments, the nanoparticulate monolayer can comprise, for example, nanoparticulates having an average diameter (D) of from 50 to 300 nm, and having a geometry selected from at least one of: spheres, hemispheres, ellipsoids, disks, pyramids, cylinders, pillars, and like shapes and geometries, or combinations thereof.

In embodiments, the nanoparticulate monolayer associated with the binder can comprise, for example, nanoparticulates that are: on the surface of the binder; partially embedded in or partially immersed in the binder; completely covered by or completely immersed in the binder, or combinations thereof.

In embodiments, the nanoparticulate monolayer associated with the binder can be, for example, partially embedded in the binder by from 0.1×D to 0.5×D, where D is the nanoparticulate average diameter (D).

In embodiments, the binder layer on the substrate can have, for example, a thickness of from 60 to 300 nm, including intermediate values and ranges.

In embodiments, the binder can comprise, for example, a polymer, a nano-particle filled material, such as a polymer or sol-gel matrix filled with silica nanoparticles having a diameter of 10 nm, an inorganic oxide material, an inorganic nitride material, a semiconductor, a transparent conductor, and like materials, or a combination thereof.

In embodiments, the binder can further comprise particles or salts of at least one of: silver, copper, compounds of silver or copper, or combinations thereof, which particular particles or salts can provide, for example, antimicrobial benefits.

In embodiments, the disclosure provides a method of making the aforementioned antireflection article, comprising:
depositing the binder layer on at least a portion of the substrate; and
depositing the nanoparticulate monolayer or near monolayer on the binder layer.

In embodiments, the method of making can further comprise, for example, fixing the nanoparticulate monolayer on or in the binder layer through, for example, curing, cross-linking, fusing, sintering, and like fixing methods, or combinations thereof.

In embodiments, the method of making can further comprise, for example, curing the binder layer before, during, after, or combinations thereof, the depositing of the nanoparticles.

In embodiments, the fixing or fusing the nanoparticulate monolayer on the binder can comprise, for example: thermal sintering; depositing a binder between the binder and the deposited nanoparticulate monolayer; depositing a second binder on the combined first binder and deposited nanoparticulate monolayer; or a combination thereof.

In embodiments, the method can further comprise, for example, chemically strengthening the article by ion exchanging at least one of: the substrate prior to depositing the binder; the binder on the substrate; the substrate prior to fixing the nanoparticulate monolayer on the binder; the substrate after depositing or after fixing the nanoparticulate monolayer, or a combination thereof.

In embodiments, the disclosure provides an article having a multilayer AR coating, where one of the layers consists of a monolayer or near-monolayer of nanoparticles. The nanoparticles comprising the monolayer or near-monolayer can have a size of, for example, from 50 to 300 nm, including intermediate values and ranges. The monolayer or near-monolayer of nanoparticles can be comprised of, for example, nano-spheres, nano-hemispheres, and like three dimensional geometries.

In embodiments, beneath the monolayer of nanoparticles there can be disposed at least one binder layer having a relatively high refractive index layer having a higher effective refractive index than the effective refractive index of the nanoparticle monolayer. The binder layer beneath the nanoparticles can serve to lower the reflection or broaden the band of low reflection that is created by the AR nano-particulate coating.

In embodiments, the present disclosure provides optical modeling results that can be useful in, for example, defining preferred ranges of thickness and refractive index range for the binder layer combined with different nanoparticle monolayer configurations, and suggesting fabrication methods. The binder layer can optionally serve other functions, for example, self-cleaning functions, for example, using TiO₂ materials, hydrophobic or oleophobic functions, or providing an adhesive, binding, or an easy-sintering surface to which the nanoparticles may bond. As an example, antimicrobial benefits can be obtained when silver, copper, compounds of silver or copper, or mixtures thereof, are incorporated in the binder layer.

In embodiments, the disclosed AR nanoparticle coatings can provide a lower reflection at a particular wavelength, or a broader wavelength band of low reflection, compared to a nanoparticle monolayer on the surface alone.

In embodiments, the disclosure provides an antireflection article comprising:

a transparent substrate having a first refractive index (nₛ);
a binder layer associated with the substrate, the binder having a second refractive index (n_{g}) that is greater than the substrate refractive index (nₛ); and
a nanoparticulate monolayer or near-monolayer associated with the binder layer, the nanoparticulate monolayer or near-monolayer having an effective refractive index (n_{p eff}) that is less than the substrate refractive index (nₛ).

In embodiments, the reflectivity of the article has an average reflectivity of less than 0.2% over a spectral width of at least 100 nm covering at least a portion of the visible wavelength spectrum from 400 to 700 nm.

In embodiments, the substrate refractive index nₛ is from about 1.4 to 1.55, the binder layer refractive index n_{g} is from about 1.55 to 1.75, and the nanoparticulate monolayer or near-monolayer effective refractive index (n_{p eff}) is from about 1.15 to 1.4.

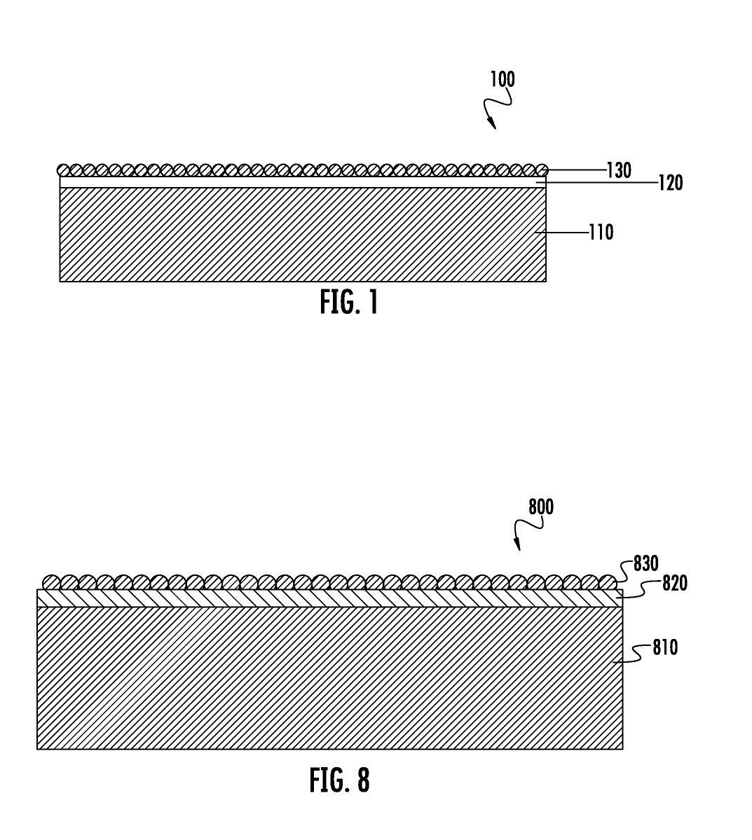

Referring to Figures, FIG. 1 shows an exemplary embodiment of an AR article (100) having a multilayer AR coating, which incorporates a nanoparticle monolayer (130) into a substrate (110) that is coated with a binder layer (120) haivng a relatively high refractive index.

In embodiments, the nanoparticles of the monolayer can be, for example, silica nanospheres deposited on top of a high refractive index binder layer coating. The individual nanospheres can have a refractive index that is close to, for example, 1.45, but the substantial portion of air or free space present within the nanoparticle monolayer or between individual nanoparticle produces an effective refractive index (n_{p eff}) for the nanoparticle monolayer that can be, for example, from 1.15 to 1.30. In embodiments, the relatively high refractive index binder layer coating can comprise at least a portion of the top surface of a transparent substrate such as glass. The nano-particles can be, for example, silica nanospheres having a diameter or size of from 50 to 300 nm, having some pitch spacing between the centers of the particles. The pitch spacing has a minimum value of D (1×diameter of the nanoparticles), and a maximum value that is not particularly limited. Preferred values of the pitch spacing relative to the diameter are discussed further below. The spacing between the nanoparticulate nanospheres need not be regular but rather the pitch can be specified as the average spacing of nanospheres over an area of (10 λₒ)² where λₒ is the central wavelength at which the AR performance is desired. The variance of the pitch over that same area should be less than about 5%.

The high refractive index of the binder layer in contact with the nano-particle monolayer can generally have a refractive index (n_{g}) of from 1.55 to 1.75, and the high refractive index layer can have a thickness of, for example, from 60 to 300 nm to provide good AR performance in the visible wavelengths. A more detailed description of the preferred ranges of high refractive index binder layer thickness is provided below.

The transparent substrate can be, for example, glass or any other transparent substrate such as plastic. The calculated refractive index ranges of preferred structures are generally valid for a transparent substrate having refractive index (nₛ) of approximately 1.48 to 1.53, while the external ambient medium is air. However, preferred structures can be modified to work well with substrates having refractive indices outside this range.

The multilayer geometry of the disclosed article was modeled using effective medium theory. This model has been shown to have excellent agreement with measured reflection of dip-coated nanoparticle coatings. Assuming a substrate refractive index (nₛ) of 1.51 and a particle refractive index (nₚ) of 1.46, the reflectivity was simulated for various high refractive index binder layer thicknesses (0 to 100×D), refractive indices (1.55 to 1.75), and pitch values (1 to 1.3×D). The reflectivity spectrum was then evaluated at each thickness-index-pitch value using the metrics of spectral broadness, flatness, and overall reflectivity level.

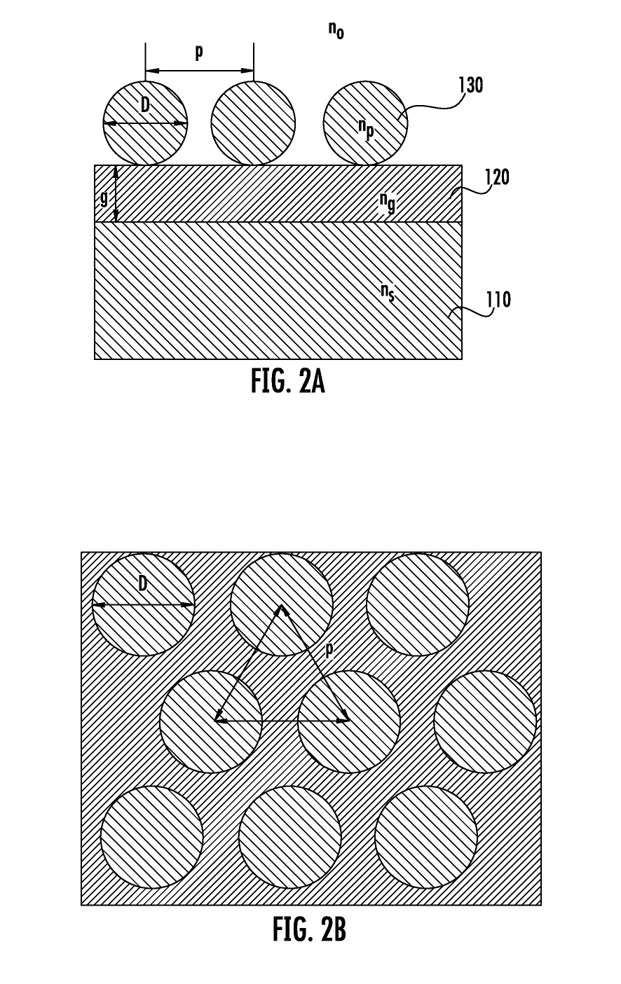

FIGS. 2A and 2B show views (2A side view; 2B top view) of an exemplary AR article having a multilayer AR coating including a nanoparticle monolayer having the nanoparticles in a non-close packed hexagonal arrangement.

FIG. 3 shows a map of coating performance for various pitch/Diameter values and the high refractive index binder layer thicknesses normalized to the particle diameter for a high refractive binder index value of 1.6. The shaded contour regions show average reflectivity for the portion of the spectrum where the reflectivity is below 0.5%; the darkest shades indicate lower values. The black contour lines correspond to the width of the spectrum over which the reflectivity is below 0.5%; this spectral width is normalized to the particle diameter. The region marked with an oval indicates a preferred design space or area where one can achieve less than 0.5% reflectivity over about 2.5×D and an average reflectivity of less than 0.2% over this band. The reflectivity scale is shown at the right.

FIG. 3 is an example of a reflectivity map versus pitch (p) and binder layer thickness (g) for a binder layer refractive index of 1.6. From this map one can determine a preferred embodiment of the disclosure to be, for example, a pitch/D of about 1.15 to about 1.25, and layer thickness (g) of 1×D to 2×D or 1.3×D to 1.8×D.

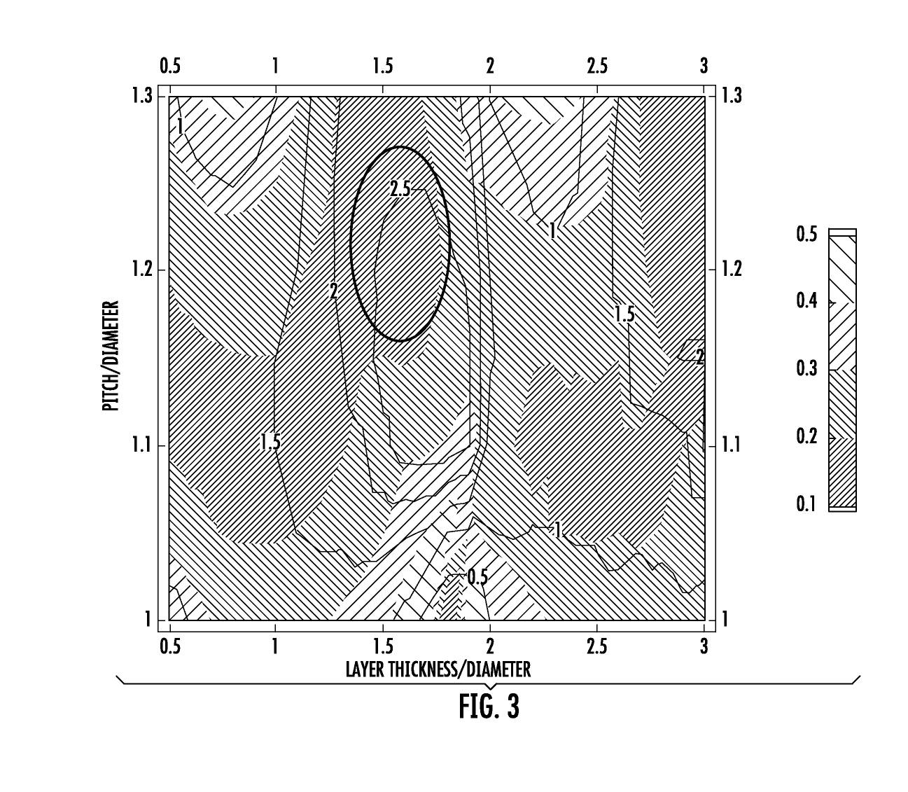

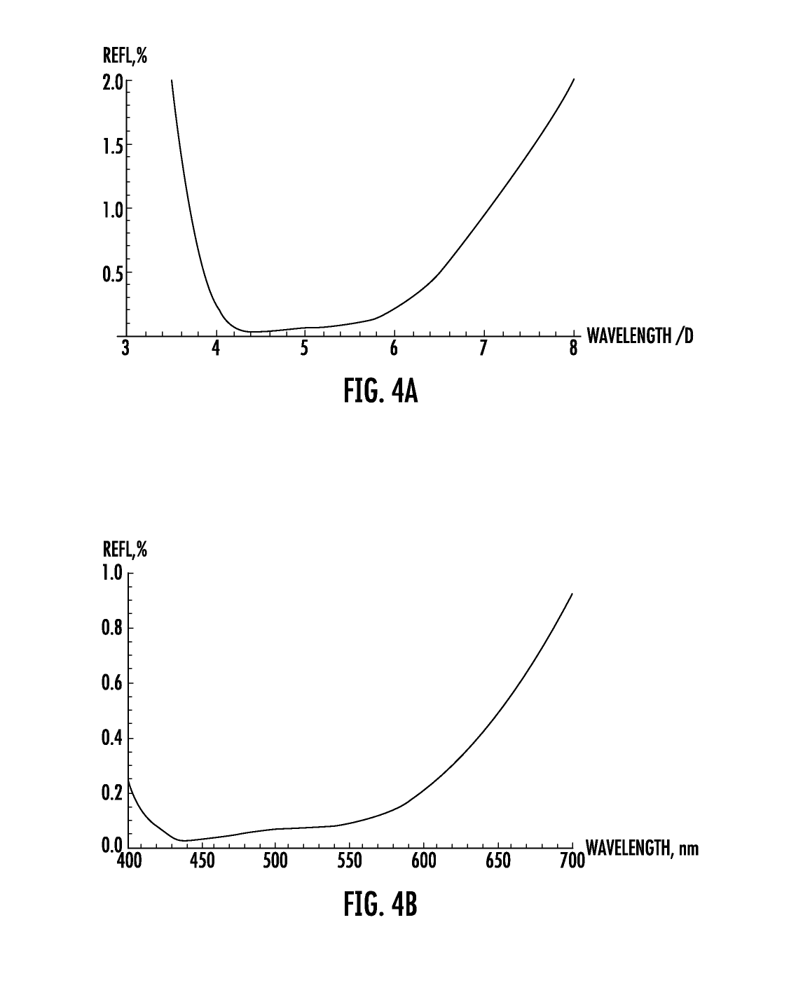

FIGS. 4A and 4B show examples of the reflectivity spectrum taken from the preferred design space of FIG. 3. FIG. 4A shows the spectrum for the average nanoparticle pitch (p) equal to 1.2 times the sphere diameter (D) of 1.2 nanometers and an high refractive index layer thickness of 1.6 times D. FIG. 4B is the same solution but shown for 100 nm diameter nanoparticles, where D equals 100 nanometers, which creates a low reflectivity band in the visible portion of the spectrum.

The FIG. 4A reflectivity spectrum has a pitch/D equal to 1.2, a refractive index (n_{g}) equal to 1.6, and a thickness/D equal to 1.6. It is often desirable to have an AR coating having good performance at visible wavelengths so that one can select, for example, D equal to 100 nm, n_{g} equal to 1.6, thickness equal to 160 nm, and pitch/D equal to 1.2 for this same design structure resulting in an average reflectivity of 0.14% from 450 to 650 nm. Table 1 lists the width of this spectrum which falls below a given reflectivity cutoff.

TABLE 1
Width of the spectrum below discrete maximum reflectivity
values for the geometry: D = 100 nm, layer index =
1.6, layer thickness = 160 nm, and pitch = 120 nm.

| | Width of spectrum |
|---|---|
| Maximum | below max reflectivity |
| reflectivity (%) | (nm) |
| 2 | 451 |
| 1.5 | 395 |
| 1 | 334 |
| 0.5 | 263 |
| 0.4 | 244 |
| 0.3 | 221 |
| 0.2 | 193 |
| 0.1 | 146 |

For an intermediate binder layer having a high refractive index of from 1.55 to 1.75, the average pitch (p) in a monolayer of silica nanospheres can be, for example, from between 1×D and 1.3×D, and preferably from 1.15×D to 1.25×D. The thickness (t) of the high refractive index layer can be, for example, from 1×D to 2×D, and more preferably from 1.3 to 1.8×D. Low reflectivity performance can be achieved with a thicker intermediate binder layer but the spectra tend to be less flat for such thicker intermediate layer approaches. However, a flat spectral response is typically more desirable. The diameter (D) of the spherical nanoparticles or nanospheres can be selected to achieve low reflection over the desired wavelength range. Exemplary preferred parameters for some high index binder layer refractive indices are given in Table 2.

TABLE 2
Examples of preferred values for the
high refractive index binder layer.

| Binder layer | pitch/Diameter | Layer thickness/diameter |
|---|---|---|
| refractive index | (p/D) range | (t/D) range |
| 1.55 | 1.1 to 1.3 | 1.3 to 1.8 |
| 1.6 | 1.15 to 1.25 | 1.3 to 1.8 |
| 1.65 | 1.15 to 1.25 | 1.4 to 1.7 |
| 1.7 | 1.1 to 1.2 | 1.3 to 1.6 |
| 1.75 | 1.1 to 1.2 | 1.3 to 1.6 |

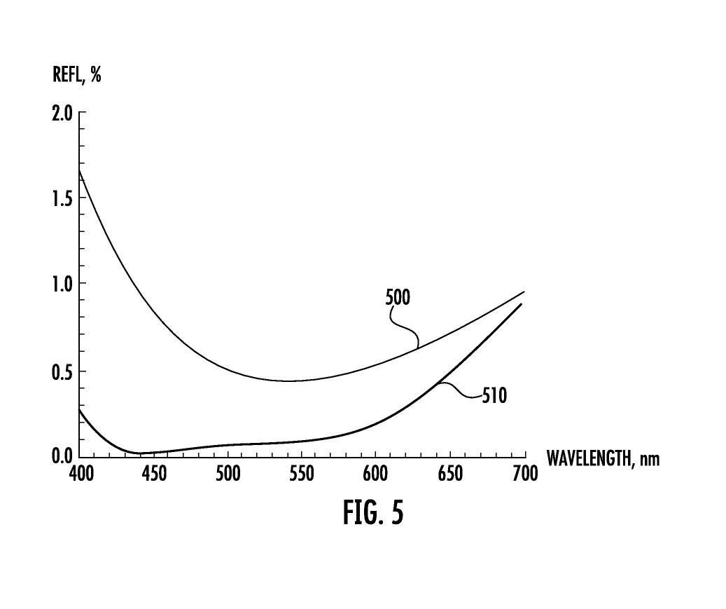

FIG. 5 shows a graph comparing modeled reflectivity spectra of two particlecoated surfaces. One surface (500) had 100 nm nanoparticles (for example, silica particles), which particles were directly deposited on a substrate and had no binder layer. The particle coated surface having no binder layer has a substrate refractive index equal to 1.51. Another particlecoated surface (510) having 100 nm nanoparticles (for example, the same silica particles as in surface (500)) and a binder layer (i.e., an intermediate binder layer having a high refractive index, for example, an SiO₂—TiO₂ sol-gel blend) is an example of a preferred design structure from FIG. 4. Depositing nanoparticle spheres on a high refractive index binder layer having a refractive index (n_{g}) equal to 1.6 broadens the low-reflectivity portion of the spectrum and lowers the overall reflectivity.

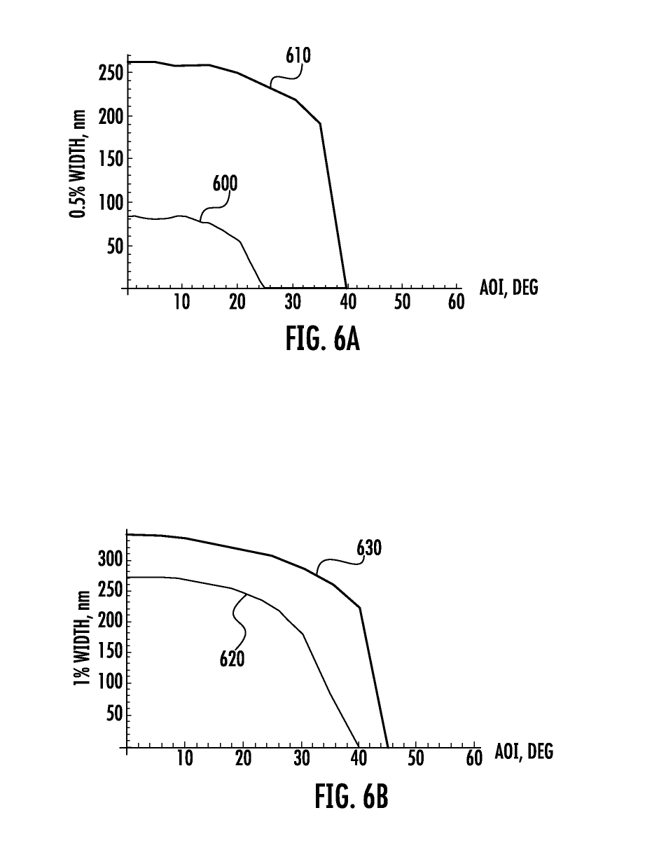

FIGS. 6A and 6B shows a graph providing a comparison of spectral widths for the two examples shown in FIG. 5 versus angle of incidence (AOI). The FIG. 6A plot shows the width, in nm, of the spectrum which is below 0.5% reflectivity, where curve (610) includes the binder layer, and curve (600) does not include the binder layer. The FIG. 6B plot shows the same result for a 1% width reflectivity cutoff, where curve (630) includes the binder layer, and curve (620) does not include the binder layer. These result demonstrate the improved angular performance that is achieveable by the disclosed article and method.

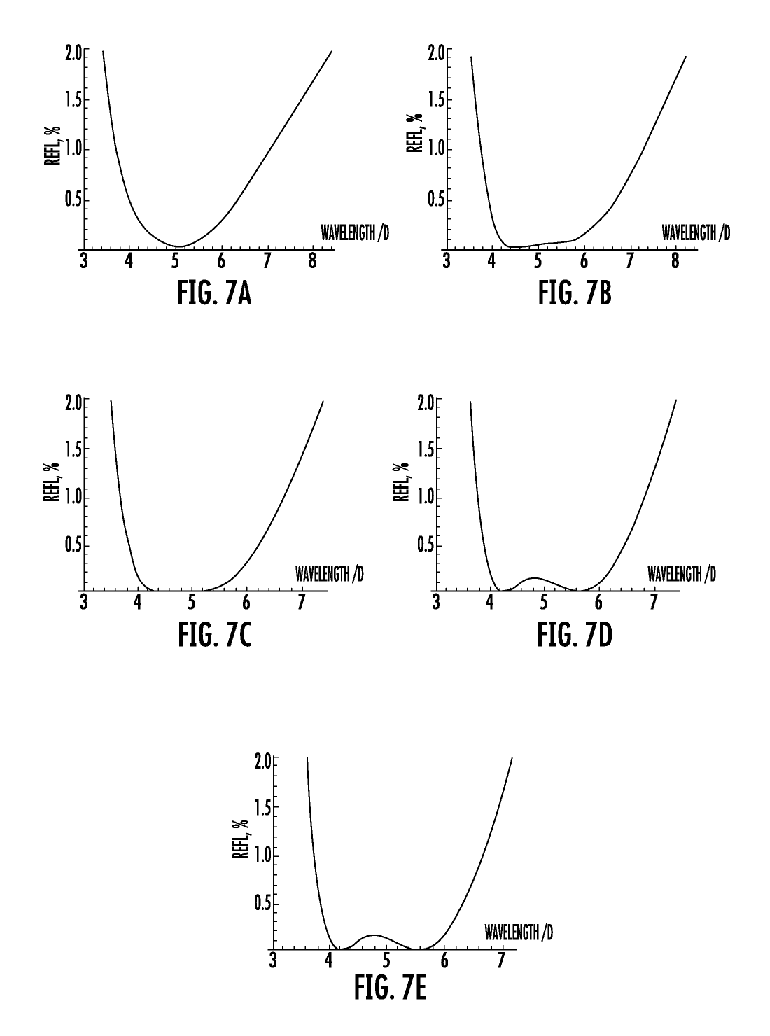

FIGS. 7A through 7E provide exemplary % refectivity spectra for some intermediate binder layer values listed in Table 3 having increasing refractive indices from 1.55 (FIG. 7A) to 1.75 (FIG. 7E).

TABLE 3
Values for selected intermediate binder layers in FIGS. 7.

| | binder layer refractive | | binder layer thickness |
|---|---|---|---|
| Fig. | index (n_{g}) | p/D | (t)(in nm) |
| 7A | 1.55 | 1.2 | 150 |
| 7B | 1.6 | 1.2 | 160 |
| 7C | 1.65 | 1.2 | 150 |
| 7D | 1.7 | 1.15 | 150 |
| 7E | 1.75 | 1.15 | 140 |

FIG. 8 provides a schematic of another exemplary article (800) having a glass substrate (810), a nanoparticle monolayer (830), which monolayer is partially sunken or immersed into a relatively high refractive index binder layer (820). To improve the hardness of the AR coating it may be desirable to partially sink the nanospheres into the binder layer as shown in FIG. 8. This can be accomplished by, for example, adding a layer of binder after depositing the spheres on the surface, or the spheres might sink into the layer during, for example, a heat treatment step. It is possible to get broadband, low reflectivity performance with the nanoparticles partially sunk into the binder layer.

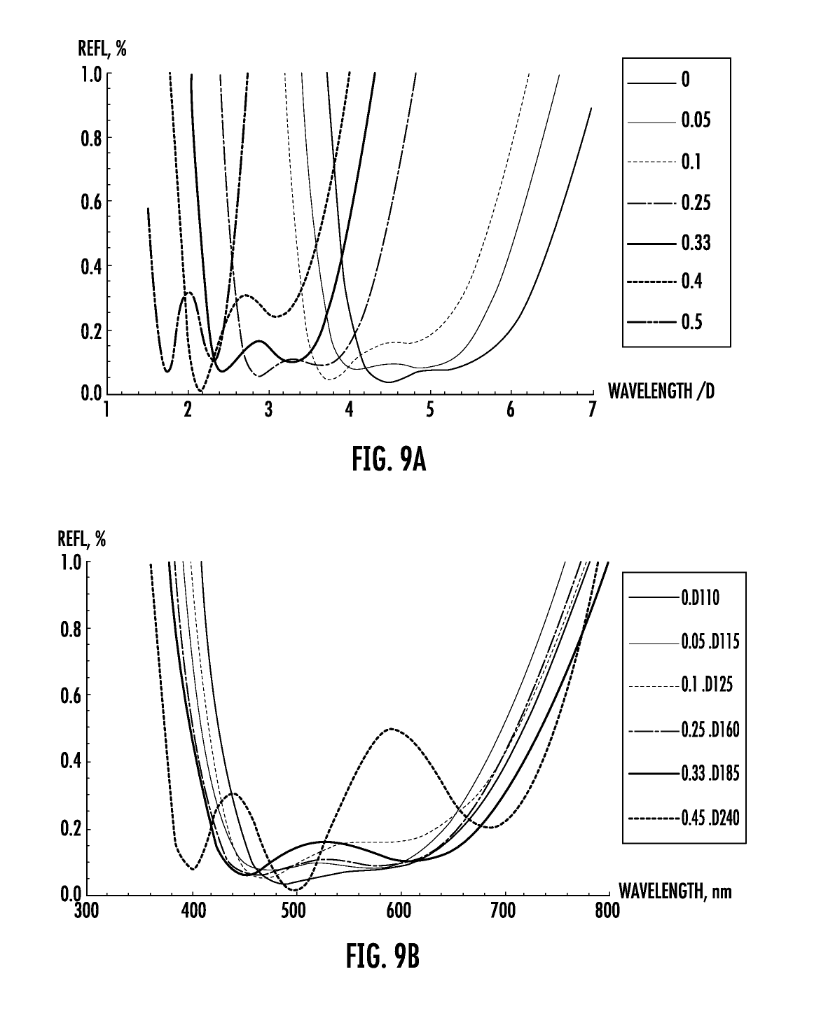

FIGS. 9A and 9B show exemplary spectra for low reflectivity structures in which the nanospheres are partially immersed into the binder layer. Spheres can be sunk by sinking fractions of a diameter as given in the plot legend (at right). The FIG. 9A plot shows that sinking particles result in a shift of the low-reflectivity region to shorter wavelengths and the bandwidth of the reflectivity normalized to the nanoparticle sphere diameter (D) also decreases. The FIG. 9B plot shows the same set of spectra now plotted for nanoparticle sphere diameters (D) which target low reflectivity in the visible spectrum. As larger diameters are required for more sinking, the actual bandwidth of the low reflectivity region increases slightly with nanoparticle sinking. The diameter (in nm) used is given along with the sinking fraction in the legend (at right). All simulations shown in FIGS. 9A and 9B used an intermediate binder layer having a refractive index of 1.6. Further parameters for these spectra are given in Table 4.

TABLE 4
Parameters for the FIG. 9B spectra.

| D (nm) | g/D | p/D | t/D | 0.5% wid/D | Ave Refl |
|---|---|---|---|---|---|
| 110 | 0 | 1.2 | 1.6 | 2.62 | 0.15 |
| 115 | 0.05 | 1.2 | 1.45 | 2.51 | 0.23 |
| 125 | 0.1 | 1.2 | 1.4 | 1.2 | 0.22 |
| 160 | 0.25 | 1.25 | 1.05 | 0.8 | 0.18 |
| 185 | 0.33 | 1.25 | 0.93 | 0.8 | 0.21 |
| 240 | 0.45 | 1.25 | 1.65 | 0.97 | 0.22 |

Particular parameters were taken from another preferred design space for each level of particle sinking: where t/D is the ratio of the binder layer thickness (t) to the particle diameter (D); g/D is the amount the nanoparticulate, such as a sphere, has sunk as a fraction of the sphere diameter, where g is the distance of sinking of the particles into the binder layer, D is the nominal diameter of the nanoparticles; p is pitch; “0.5% wid” is the width of the spectrum where the reflectivity is below 0.5%; and “Ave Refl” refers to the average reflectivity of the spectrum that lies below 0.5% reflectivity.

As shown by spectra in FIG. 9, desirable AR performance can be achieved with nanospheres sunk from 0 to 0.33×D and even up to 0.5×D. Sinking the particles into the high refractive index binder layer does change the desired design space somewhat and for a given particle diameter, for example, the low reflectivity region shifts to shorter wavelengths as the sinking fraction increases. Referring again to FIG. 9A, it is necessary to increase the nanosphere diameter as the sinking fraction is increased to maintain low reflectivity performance in the same wavelength band. In this instance, the spectral bandwidth remains mostly unchanged although trending slightly towards a larger bandwidth for larger sinking fractions.

The fabrication methods of the disclosure are not particularly limited. In embodiments, the binder layer coating can be deposited on the transparent substrate by any of a variety of thin-film coating methods known in the art, including, for example, thermal evaporation, e-beam evaporation, DC sputtering, reactive AC sputtering, CVD, liquid-based sol-gel or polymer coatings, spin coating, dip coating, spray coating, slot/slit coating, roll coating, and like coating methods, or combinations thereof. Materials for the binder layer, that is the binder layer coating, can include, for example, polymers such as acrylate polymers, polyesters, polyimides, nano-particle filled materials, and inorganics such as SiO₂—TiO₂ blends, SiOx-SiNy blends (see for example, Nanoscale Research Letters, February 2012, 7:124), Al₂O₃, nitrides and oxynitrides such as AlOxNy, SiAlxOyNz, Si3N4, TiN, TiNwOv (see for example, US Patent Appln Pub. 20110020638), and like materials, or combinations thereof.

In embodiments, the binder layer can be formed from, for example, a SiO₂—TiO₂ sol-gel blend that is tailored to have a refractive index of 1.60, and having a thickness (t) of 100 to 150 nm. This sol-gel binder layer or coat can be prepared by, for example, dip, spin, spray coating, or like methods, and then cured at 150 to 550° C. Subsequently, the nanoparticle monolayer can be deposited on top of the SiO₂—TiO₂ layer. The nanoparticle monolayer can be deposited from an aqueous or solvent-based suspension using, for example, dip coating, spin coating, spray coating, and like methods, or combinations thereof. The nanoparticle monolayer can optionally be fused to the surface of the high index binder layer by, for example, thermal sintering. The nano-particle monolayer can optionally be fused to the surface of the high refractive index binder layer by, for example, the addition of a very thin layer, for example, on the surface of the particles or at the interface between the binder layer and the nanoparticles. The very thin, such as having a thickness of from 1 to 20 nm, layer of, for example, silane, polymer, copolymer, adhesive, siloxane, sol-gel SiO₂ material, or like materials, applied by, for example, dip or spray coating, of yet another material can act as an additional or second binder material.

In embodiments, the nanoparticle monolayer can be formed first on an alkali silicate glass substrate using, for example, dip coating, spin coating, spray coating, and like methods, or combinations thereof. The nanoparticle monolayer can optionally be fused to the surface of the alkali silicate glass through thermal sintering. The alkali silicate glass can then be optionally chemically strengthened by, for example, ion-exchange of smaller ions in the glass with larger native ions, e.g., native sodium ions exchanged with potassium ions. Finally, the refractive index of the glass surface below the nanoparticle monolayer, can be raised by ion-exchanging in a bath containing metal ions having a high relative permittivity, such as silver ions. Such ion-exchange reactions have been shown to raise the refractive index of alkali silicates from, for example, 1.51 to 1.61 (see for example: R. Araujo, “Colorless glasses containing ion-exchanged silver” Applied Optics, v. 31, 25, pp. 5221-5224). To create a thin layer of high-index material using an ion-exchange process, it may be desirable to perform the ion exchange at low temperatures and for short times, for example, less than 450° C., or even less than 350° C., such as from 250 to 400° C., and for a time interval of less than 1 hour, less than 20 minutes, or even less than 5 minutes, such as from 1 to 60 minutes, including intermediate values and ranges. In some instances it may be preferable to use electrostatically-driven ion exchange at low temperature to form a sharp diffusion profile.

In embodiments, the glass substrate or glass article can comprise, consist essentially of, or consist of one of a soda lime silicate glass, an alkaline earth aluminosilicate glass, an alkali aluminosilicate glass, an alkali borosilicate glass, and combinations thereof. In embodiments, the glass article can be, for example, an alkali aluminosilicate glass having the composition: 60-72 mol % SiO₂; 9-16 mol % Al₂O₃; 5-12 mol % B₂O₃; 8-16 mol % Na₂O; and 0-4 mol % K₂O, wherein the ratio

$$\frac{{Al}_{2} {O}_{3} ( mol \% ) + {B}_{2} {O}_{3} ( mol \% )}{{\sum }^{ } alkali metal modifiers ( mol \% )} > 1 ,$$

where the alkali metal modifiers are alkali metal oxides. In embodiments, the alkali aluminosilicate glass substrate can be, for example: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO. In embodiments, the alkali aluminosilicate glass substrate can be, for example: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol % Li₂O+Na₂O+K₂O≦20 mol % and 0 mol % MgO+CaO≦10 mol %. In embodiments, the alkali aluminosilicate glass substrate can be, for example: 64-68 mol % SiO₂; 12-16 mol % Na₂O; 8-12 mol % Al₂O₃; 0-3 mol % B₂O₃; 2-5 mol % K₂O; 4-6 mol % MgO; and 0-5 mol % CaO, wherein: 66 mol % SiO₂+B₂O₃+CaO≦69 mol %; Na₂O+K₂O+B₂O₃+MgO+CaO+SrO>10 mol %; 5 mol % MgO+CaO+SrO≦8 mol %; (Na₂O+B₂O₃)—Al₂O₃ 2 mol %; 2 mol % Na₂O—Al₂O₃≦6 mol %; and 4 mol %≦(Na₂O+K₂O)—Al₂O₃≦10 mol %. In embodiments, the alkali aluminosilicate glass can be, for example: 50-80 wt % SiO₂; 2-20 wt % Al₂O₃; 0-15 wt % B₂O₃; 1-20 wt % Na₂O; 0-10 wt % Li₂O; 0-10 wt % K₂O; and 0-5 wt % (MgO+CaO+SrO+BaO); 0-3 wt % (SrO+BaO); and 0-5 wt % (ZrO₂+TiO₂), wherein 0≦(Li₂O+K₂O)/Na₂O≦0.5. In embodiments, the alkali aluminosilicate glass can be, for example, substantially free of lithium. In embodiments, the alkali aluminosilicate glass can be, for example, substantially free of at least one of arsenic, antimony, barium, or combinations thereof. In embodiments, the glass can optionally be batched with 0 to 2 mol % of at least one fining agent, such as Na₂SO₄, NaCl, NaF, NaBr, K₂SO₄, KCl, KF, KBr, SnO₂, at like substances, or combinations thereof.

In embodiments, the selected glass can be, for example, down drawable, i.e., formable by methods such as slot draw or fusion draw processes that are known in the art. In these instances, the glass can have a liquidus viscosity of at least 130 kpoise. Examples of alkali aluminosilicate glasses are described in commonly owned and assigned U.S. patent application Ser. No. 11/888,213, to Ellison, et al., entitled “Down-Drawable, Chemically Strengthened Glass for Cover Plate,” filed Jul. 31, 2007, which claims priority from U.S. Provisional Application 60/930,808, filed May 22, 2007; U.S. patent application Ser. No. 12/277,573, to Dejneka, et al., entitled “Glasses Having Improved Toughness and Scratch Resistance,” filed Nov. 25, 2008, which claims priority from U.S. Provisional Application 61/004,677, filed Nov. 29, 2007; U.S. patent application Ser. No. 12/392,577, to Dejneka, et al., entitled “Fining Agents for Silicate Glasses,” filed Feb. 25, 2009, which claims priority from U.S. Provisional Application No. 61/067,130, filed Feb. 26, 2008; U.S. patent application Ser. No. 12/393,241, to Dejneka, et al., entitled “Ion-Exchanged, Fast Cooled Glasses,” filed Feb. 26, 2009, which claims priority to U.S. Provisional Application No. 61/067,732, filed Feb. 29, 2008; U.S. patent application Ser. No. 12/537,393, to Barefoot, et al., entitled “Strengthened Glass Articles and Methods of Making,” filed Aug. 7, 2009, which claims priority to U.S. Provisional Application No. 61/087,324, entitled “Chemically Tempered Cover Glass,” filed Aug. 8, 2008; U.S. Provisional Patent Application No. 61/235,767, to Barefoot, et al., entitled “Crack and Scratch Resistant Glass and Enclosures Made Therefrom,” filed Aug. 21, 2009; and U.S. Provisional Patent Application No. 61/235,762, to Dejneka, et al., entitled “Zircon Compatible Glasses for Down Draw,” filed Aug. 21, 2009.

The glass surfaces and sheets described in the following example(s) can use any suitable particle-coatable glass substrate, or like substrates, and can include, for example, a glass composition 1 through 11, or a combination thereof, listed in Table 5.

TABLE 5
Representative transparent glass substrate compositions.

| Glass> | | | | | | | | | | | |
|---|---|---|---|---|---|---|---|---|---|---|---|
| Oxides | | | | | | | | | | | |
| (mol %) | 1 | 2 | 3 | 4 | 5 | 6 | 7 | 8 | 9 | 10 | 11 |
| SiO₂ | 66.16 | 69.49 | 63.06 | 64.89 | 63.28 | 67.64 | 66.58 | 64.49 | 66.53 | 67.19 | 70.62 |
| Al₂O₃ | 10.29 | 8.45 | 8.45 | 5.79 | 7.93 | 10.63 | 11.03 | 8.72 | 8.68 | 3.29 | 0.86 |
| TiO₂ | 0 | | | — | — | 0.64 | 0.66 | 0.056 | 0.004 | — | 0.089 |
| Na₂O | 14 | 14.01 | 15.39 | 11.48 | 15.51 | 12.29 | 13.28 | 15.63 | 10.76 | 13.84 | 13.22 |
| K₂O | 2.45 | 1.16 | 3.44 | 4.09 | 3.46 | 2.66 | 2.5 | 3.32 | 0.007 | 1.21 | 0.013 |
| B₂O₃ | 0.6 | | 1.93 | — | 1.9 | — | — | 0.82 | — | 2.57 | — |
| SnO₂ | 0.21 | 0.185 | — | — | 0.127 | — | — | 0.028 | — | — | — |
| BaO | 0 | — | — | — | — | — | — | 0.021 | 0.01 | 0.009 | — |
| As₂O₃ | 0 | — | — | — | — | 0.24 | 0.27 | | — | 0.02 | — |
| Sb₂O₃ | — | — | 0.07 | — | 0.015 | — | 0.038 | 0.127 | 0.08 | 0.04 | 0.013 |
| CaO | 0.58 | 0.507 | 2.41 | 0.29 | 2.48 | 0.094 | 0.07 | 2.31 | 0.05 | 7.05 | 7.74 |
| MgO | 5.7 | 6.2 | 3.2 | 11.01 | 3.2 | 5.8 | 5.56 | 2.63 | 0.014 | 4.73 | 7.43 |
| ZrO₂ | 0.0105 | 0.01 | 2.05 | 2.4 | 2.09 | — | — | 1.82 | 2.54 | 0.03 | 0.014 |
| Li₂O | 0 | — | — | — | — | — | — | — | 11.32 | — | — |
| Fe₂O₃ | 0.0081 | 0.008 | 0.0083 | 0.008 | 0.0083 | 0.0099 | 0.0082 | 0.0062 | 0.0035 | 0.0042 | 0.0048 |
| SrO | — | — | — | 0.029 | — | — | — | — | — | — | — |

### EXAMPLES

The following examples serve to more fully describe the manner of using the above-described disclosure, and to further set forth the best modes contemplated for carrying out various aspects of the disclosure. It is understood that these examples do not limit the scope of this disclosure, but rather are presented for illustrative purposes. The working examples further describe how to prepare the articles of the disclosure.

### Preparation of Particle-Coated Surfaces

### Example 1 (Prophetic)

### Preparation of the High Refractive Index Binder Layer

200 mL of methanol is mixed with 25 mL of TEOS (tetra-ethyl-ortho-silicate or tetraethoxysilane, Aldrich) and 25 mL of 0.01M HCl in water, providing a solution having a pH of about 3. This mixture is stirred under reflux heating at about 65° C. for two hours, forming solution “A”. Separately, 126.5 mL of 2-ethoxyethanol is mixed with 2.86 mL of DI water, 0.64 mL of 69% HNO₃, and 18.18 mL of Ti(IV) isopropoxide, in that order while stirring, and the complete mixture is stirred for 1 hour under ambient conditions, forming solution “B”. Next, 1.6 mL of solution “B” is mixed with 1.8 mL of solution “A” and 2.0 mL of 2-propanol to form coating solution “C”. Coating solution “C” is spin coated onto a glass substrate (such as Corning Gorilla™ or Corning EagleXG™ glasses) at about 575 rpm for 60 seconds, then cured at 410° C. for 1 hour and 15 minutes in air, thus forming a binder layer coat having a relatively high refractive index (n_{g}) of about 1.67 and a thickness (t) of about 75 nm. This binder coating procedure can be repeated a second time to form a coating thickness of about 150 nm. Slight modifications to the concentrations and coating conditions can be utilized to prepare other binder layer coating thicknesses.

### Example 2 (Prophetic)

### Preparation of Nanoparticulate Coating

Silica nanospheres of approximately 100 nm in diameter are dispersed in 2-propanol to form a suspension of about 1.5% solids content. The pH of the suspension is adjusted to about 3.5 by adding HCl. The solution can be ultrasonicated, if needed, to promote good particle dispersion. Glass coupon samples are dip-coated in the nanoparticle suspension, using a withdrawal speed of 30 to 35 mm/min to form substantially a monolayer of 100 nm SiO₂ nanoparticles on the glass surface. This procedure can be modified by adjusting pH, solids content, temperature, humidity, and dip coating speed as needed to form a similar coating on top of the first binder layer described above, and the particles can be sintered or partially sintered to the relatively high refractive index binder layer by heat treating at 400 to 600° C. for 1 hour or more.

### Example 3 (Prophetic)

### Preparation of Particulated Surfaces Having Substantially Uniform Spacing or Separation Between Adjacent Particles, e.g., Uniformly Spaced and Non-Close Pack Hexagonal Geometry of Adjacent Particles

Recently several methods have been demonstrated for fabricating non-close-packed nanoparticle monolayers with controlled spacing between particles on various substrates, including demonstrations of anti-reflective effects. These methods include convective assembly on a lithographic pattern (see Hoogenboom, et. al., “Template-Induced Growth of Close-Packed and Non-Close-Packed Colloidal Crystals during Solvent Evaporation”, Nano Letters, 4, 2, p. 205, 2004.); dip-coating of hydrogel spheres, which can be made to shrink during drying or heating after deposition (see Zhang, et. al., “Two-Dimensional Non-Close-Packing Arrays Derived from Self-Assembly of Biomineralized Hydrogel Spheres and Their Patterning Applications”, Chem. Mater. 17, p. 5268, 2005, and FIG. 3 and associated text); spin-coating and shear alignment of SiO₂ nanospheres, optionally with further material added to this template (see Venkatesh et. al., “Generalized Fabrication of Two-Dimensional Non-Close-Packed Colloidal Crystals,” Langmuir, 23, p. 8231, 2007, and FIG. 5 and associated text); and electrostatically controlled self-assembly at air-water or alkane-water interfaces with transfer to a substrate, optionally using a very thin (about 17 nm) adhesive layer (see Ray, et. al., “Submicrometer Surface Patterning Using Interfacial Colloidal Particle Self-Assembly”, Langmuir, 25, p. 7265, 2009, and FIG. 8 and associated text; Bhawalkar, et. al., “Development of a Colloidal Lithography Method for Patterning Nonplanar Surfaces”, Langmuir, 26, p. 16662, 2010). However, these previous works did not specify, for example, the desired relationships between the particle size, the particle spacing, the particle sinking into a substrate or binder layer, and the high refractive index binder layer. Such relationships are specified in the present disclosure and achieve excellent low-reflection performance for visible light, together with enhanced durability due to the optional particle sinking or sintering.

The disclosure has been described with reference to various specific embodiments and techniques. However, it should be understood that many variations and modifications are possible while remaining within the scope of the disclosure.

What is claimed is:

1. An antireflection article comprising:
a transparent substrate having a refractive index (nₛ) of from 1.48 to 1.53;
a binder layer associated with the substrate, the binder having a refractive index (n_{g}) of from 1.55 to 1.75; and
a nanoparticulate monolayer or near-monolayer associated with the binder layer, the nanoparticulate monolayer or near-monolayer having an effective refractive index (n_{p eff}) of less than the refractive index of the binder layer.

2. The antireflection article of claim 1 wherein the effective refractive index (n_{p eff}) of the nanoparticulate monolayer is from 1.15 to 1.3.

3. The antireflection article of claim 1 wherein the reflectivity of the article has an average reflectivity of less than 0.2% over a spectral width of at least 100 nm covering at least a portion of the visible wavelength spectrum from 400 to 700 nm.

4. The antireflection article of claim 1 wherein the nanoparticulate monolayer comprises nanoparticulates in a non-close packed hexagonal geometry having a pitch (p) to nanoparticulate diameter (D) ratio (p/D) of from 1.15 to 1.25.

5. The antireflection article of claim 1 wherein the binder has a thickness (g) from 1×D to 2×D where D is the nanoparticulate average diameter (D).

6. The antireflection article of claim 1 wherein the transparent substrate is a glass, a polymer, a glass-ceramic, a crystalline oxide, a semiconductor, or combinations thereof.

7. The antireflection article of claim 1 wherein the nanoparticulate monolayer has a nanoparticulate surface coverage of from 90 to 93%, and the nanoparticulate near-monolayer substantially comprises a monolayer of the nanoparticulates having a nanoparticulate surface coverage of from 65 to 90%.

8. The antireflection article of claim 1 wherein the nanoparticulates comprise nanoparticulates of at least one of silica, alumina, zirconia, polystyrene, latex, or combinations thereof.

9. The antireflection article of claim 1 wherein the nanoparticulate monolayer comprises nanoparticulates having an average diameter (D) of from 50 to 300 nm, and having a geometry selected from at least one of: spheres, hemispheres, ellipsoids, disks, pyramids, cylinders, pillars, or combinations thereof.

10. The antireflection article of claim 1 wherein the nanoparticulate monolayer associated with the binder comprises nanoparticulates that are: on the surface of the binder; partially embedded in the binder; completely covered by the binder, or combinations thereof.

11. The antireflection article of claim 1 wherein the nanoparticulate monolayer associated with the binder is partially embedded in the binder by from 0.1×D to 0.5×D, where D is the nanoparticulate average diameter (D).

12. The antireflection article of claim 1 wherein the binder on the substrate has a thickness of from 60 to 300 nm.

13. The antireflection article of claim 1 wherein the binder comprises at least one of a polymer, a nano-particle filled material, an inorganic oxide material, an inorganic nitride material, a semiconductor, a transparent conductor, or a combination thereof.

14. The antireflection article of claim 13 wherein the binder further comprises particles or salts of at least one of: silver, copper, or combinations thereof.

15. A method of making the antireflection article of claim 1, comprising:
depositing the binder on the substrate;
depositing nanoparticles to form the nanoparticulate monolayer or near monolayer on the binder; and
fixing the nanoparticles of the nanoparticulate monolayer or near monolayer on the binder layer.

16. The method of claim 15 wherein fixing the nanoparticulate monolayer on the binder layer comprises: thermal sintering; depositing a second binder between the binder and the deposited nanoparticulate monolayer; depositing a second binder on the combined binder and deposited nanoparticulate monolayer; depositing a second binder between adjacent nanoparticulates of the deposited nanoparticulate monolayer, or a combination thereof.

17. The method of claim 15 further comprising chemically strengthening the article by ion exchanging at least one of: the substrate prior to depositing the binder; the binder on the substrate; the substrate prior to fixing the nanoparticulate monolayer on the binder; the substrate after depositing or after fixing the nanoparticulate monolayer, or a combination thereof.

18. An antireflection article comprising:
a transparent substrate having a first refractive index (nₛ);
a binder layer associated with the substrate, the binder having a second refractive index (n_{g}) that is greater than the substrate refractive index (nₛ); and
a nanoparticulate monolayer or near-monolayer associated with the binder layer, the nanoparticulate monolayer or near-monolayer having an effective refractive index (n_{p eff}) that is less than the substrate refractive index (nₛ).

19. The antireflection article of claim 18, wherein the reflectivity of the article has an average reflectivity of less than 0.2% over a spectral width of at least 100 nm covering at least a portion of the visible wavelength spectrum from 400 to 700 nm.

20. The antireflection article of claim 18, wherein the substrate refractive index nₛ is from about 1.4 to 1.55, the binder layer refractive index n_{g} is from about 1.55 to 1.75, and the nanoparticulate monolayer or near-monolayer effective refractive index (n_{p eff}) is from about 1.15 to 1.4.
